(19) United States
(12) Patent Application Publication
(10) Pub. No.: US 2008/0029279 A1
(43) Pub. Date: Feb. 7, 2008

(54) Ground-working tool

(76) Inventors: Louis Zuccarello, Whitestone, NY (US); Franco Romito, Whitestone, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/598,530

(22) Filed: Nov. 13, 2006

Related U.S. Application Data
(60) Provisional application No. 60/834,642, filed on Aug. 1, 2006.

(51) Int. Cl. A01B 33/00

(52) U.S. Cl. 172/42

(57) ABSTRACT

A ground-working tool is including a shaft, a drive motor, a gear set, at least one arm and at least one head is disclosed. The drive motor is disposed in mechanical cooperation with the shaft. The gear set is configured to be driven by the drive motor. The arm is disposed in mechanical cooperation with the gear set and defines a longitudinal axis. The head is disposed in mechanical cooperation with the arm. The arm is movable proximally and distally in a reciprocating motion.

### CROSS REFERENCE TO RELATED APPLICATION

This application claims the benefits of and priority to U.S. Provisional Patent Application Ser. No. 60/834,642 entitled “SOIL CULTIVATOR” which was filed on Aug. 1, 2006, the entire contents of which are hereby incorporated by reference herein.

### BACKGROUND

1. Field of the Disclosure

The present disclosure relates to a ground-working tool. More particularly, the present disclosure relates to a hand-held tool for cultivating soil.

2. Background of the Art

Cultivation of an area of soil, e.g., a garden plot, is a time-consuming but important task to ensure plants having good yield and a healthy-looking yard or garden. Typically, a gardener will use an tool, such as a hoe, to loosen and turn the soil between adjacent rows of plants and/or to remove any undesired growths, such as weeds. In addition to destroying weeds, soil that has become hard and packed down e.g., from watering, is loosened. This allows air to penetrate the soil and also facilitates watering the plants. Since this type of cultivation can be extremely time consuming and requires substantial physical labor, several power-driven tools have been developed for cultivation.

Many power-driven tools have blades or tool heads that rotate 360°. Such a complete rotation often creates various hazards, including projecting stones, pebbles, plastic, etc., which can injure a worker, bystander or nearby property. Additionally, weeds and grass are known to become tangled in cultivation devices that rotate 360°. Accordingly, a ground-working tool have at least one reciprocating blade would be a welcome addition to the art.

### SUMMARY

The present disclosure relates to a ground-working tool including a shaft, a drive motor, a gear set, at least one arm and at least one head is disclosed. The drive motor is disposed in mechanical cooperation with the shaft. The gear set is configured to be driven by the drive motor. The arm is disposed in mechanical cooperation with the gear set and defines a longitudinal axis. The head is disposed in mechanical cooperation with the arm. The arm is movable (e.g., confined to move) proximally and distally in a reciprocating motion.

In an embodiment, the at least one arm includes a first arm defining a first longitudinal axis and a second arm defining a second longitudinal axis. Activation of the drive motor causes the first arm and the second arm to reciprocatingly move in opposite directions from one another. In an embodiment, the first longitudinal axis and the second longitudinal axis are substantially to one another. In another embodiment, the first and second longitudinal axes are disposed at an angle Θ to each other—the angle Θ being between about 5° and about 35°.

In a disclosed embodiment the head includes a plurality of tines. In another embodiment, the head includes a blade having an elongated cutting surface where the elongated cutting surface is disposed substantially parallel to the longitudinal axis.

In an embodiment, the head is removably secured to the arm. Additionally, it is disclosed that at least a portion of the tool is configured to be hand-held.

The present disclosure also relates to a ground-working attachment that is removably securable to a hand held motorized shaft. The attachment includes, a housing, a gear set, at least one arm and at least one head. The gear set is disposed at least partially within the housing. The arm is disposed in mechanical cooperation with the gear set and defines a longitudinal axis. The head is disposed in mechanical cooperation with the arm. The arm is movable proximally and distally in a reciprocating motion.

The present disclosure also relates to a method of cultivating soil. The method includes the steps of providing a tool (such as a ground-working tool described above), activating the drive motor to cause the arm to reciprocate and placing at least a portion of the tool adjacent soil.

### BRIEF DESCRIPTION OF THE DRAWINGS

Embodiments of the present disclosure are described hereinbelow with reference to the drawings wherein:

FIG. 1 is a perspective view of a ground-working tool according to an embodiment of the present disclosure;

FIG. 1A is an enlarged perspective view of the ground-working tool according to FIG. 1;

FIGS. 2 and 3 are top views of a working end of the ground-working tool of FIG. 1, in accordance with an embodiment of the present disclosure;

FIGS. 4-6 are top views of a pair of heads of the ground-working tool of FIGS. 1-3, in accordance with an embodiment of the present disclosure;

FIG. 7 is a side view of an embodiment of the working end of the ground-working tool of FIGS. 1-6;

FIG. 8 is a perspective view of an embodiment of the working end of the ground-working tool of FIGS. 1-7;

FIG. 9 is an assembly view of the working end of the ground-working tool of FIGS. 1-8; in accordance with an embodiment of the present disclosure; and

FIGS. 10-13 are top views of a gear set of the ground-working tool of FIGS. 1-9, in accordance with an embodiment of the present disclosure.

### DETAILED DESCRIPTION

Embodiments of the presently disclosed ground-working tool are now described in detail with reference to the drawings, in which like reference numerals designate identical or corresponding elements in each of the several views. As used herein the term “distal” refers to that portion of the ground-working tool, or component thereof, farther from the user while the term “proximal” refers to that portion of the ground-working tool or component thereof, closer to the user.

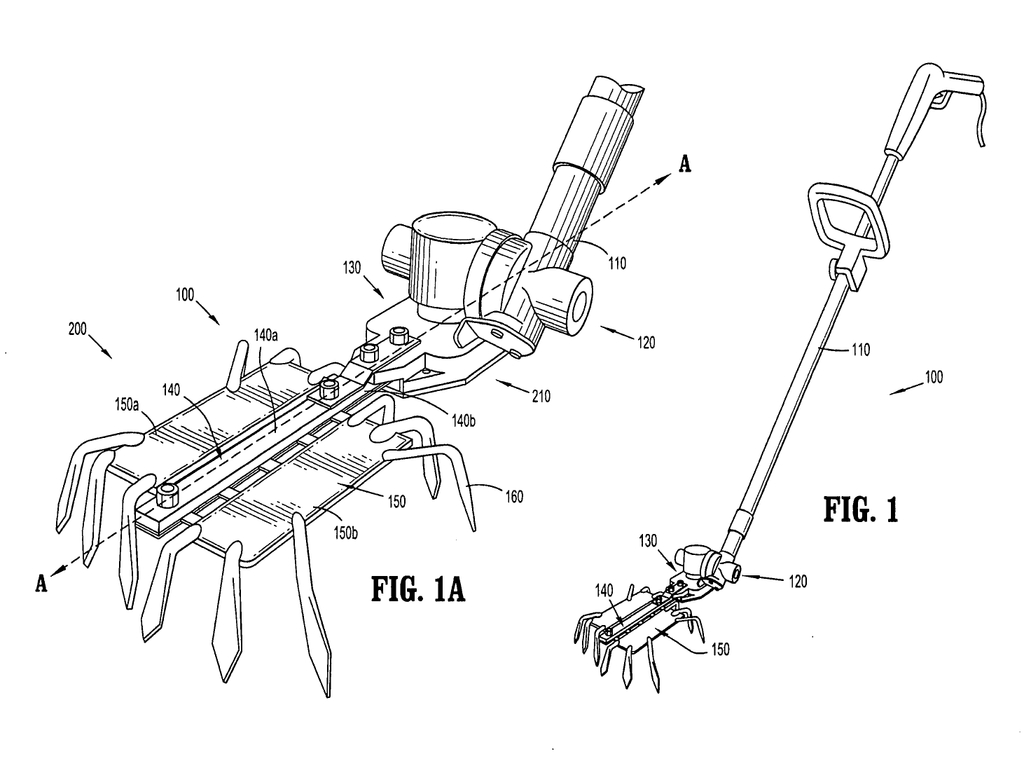

A ground-working tool, e.g., a soil cultivator, in accordance with the present disclosure is referred to in the figures as reference numeral 100. Referring initially to FIGS. 1 and 1A, ground-working tool 100 includes a shaft 110, a drive motor 120, a gear set 130, at least one arm 140 and at least one head 150. Drive motor 120 is disposed in mechanical cooperation with shaft 110 and gear set 130 is configured to be driven by drive motor 120. Any conventional methods, such as electric, battery or gas, for example, may be used to power drive motor 120. At least one arm 140 (two arms 140a and 140b are illustrated in FIG. 1A) is disposed in mechanical cooperation with gear set 130 and defines longitudinal axis A-A. At least one head 150 (two heads 150a and 150b are illustrated in FIG. 1A) is disposed in mechanical cooperation with at least one arm 140. Ground-working tool 100 of the present disclosure is illustrated as a hand-held tool, but it is envisioned that ground-working tool 100 is a functional tool without being of a hand-held variety.

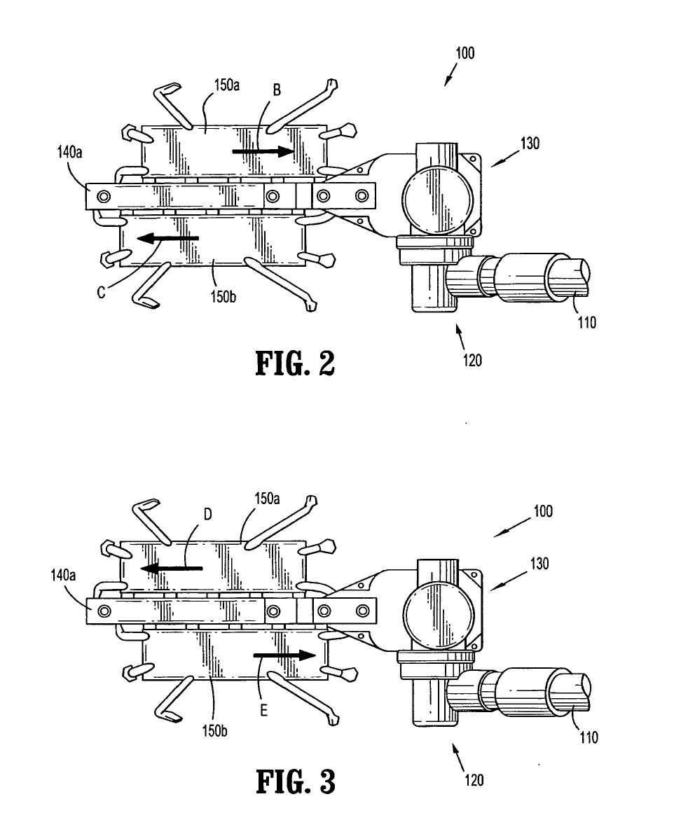

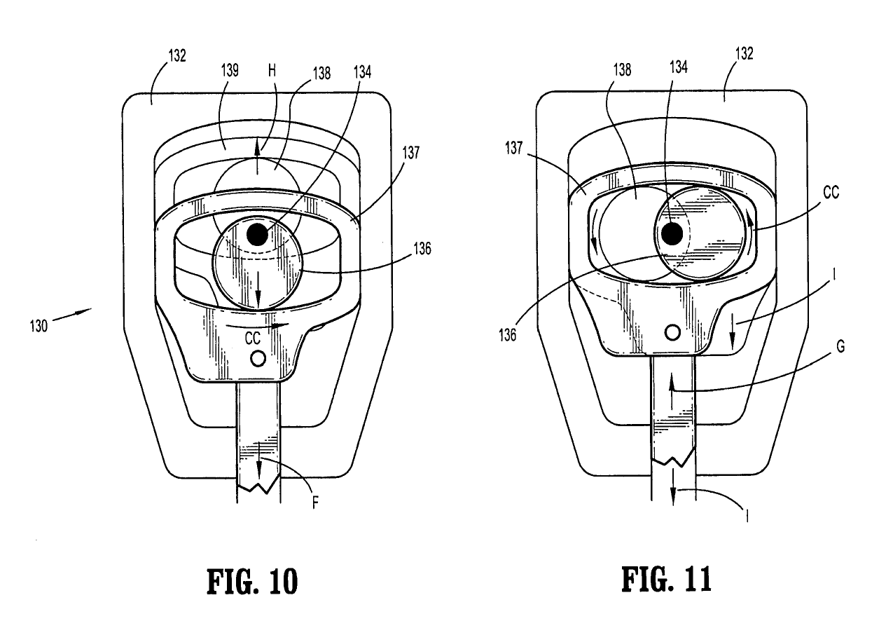

Referring now to FIGS. 2 and 3, ground-working tool 100 is configured to provide reciprocating motion to arm 140. Each arm 140a, 140b (arm 140b is hidden from view in FIGS. 2 and 3) is in mechanical cooperation with a portion of gear set 130, which produces the desired motion (as discussed in detail below with reference to FIGS. 10-13). In the illustrated examples, two arms 140a and 140b reciprocatingly move proximally and distally, in opposite directions from each other. As further illustrated, heads 150a and 150b are disposed in mechanical cooperation with each arm 140a and 140b, respectively. More specifically, with reference to FIG. 2, as arm 140a (and head 150a) moves proximally in the direction of arrow B, arm 140b (and head 150b) moves distally in the direction of arrow C. With reference to FIG. 3, after arms 140a and 140b have reached their respective proximal and distal limits, arm 140a (and head 150a) moves distally in the direction of arrow D and arm 140b (and head 150b) moves proximally in the direction of arrow E.

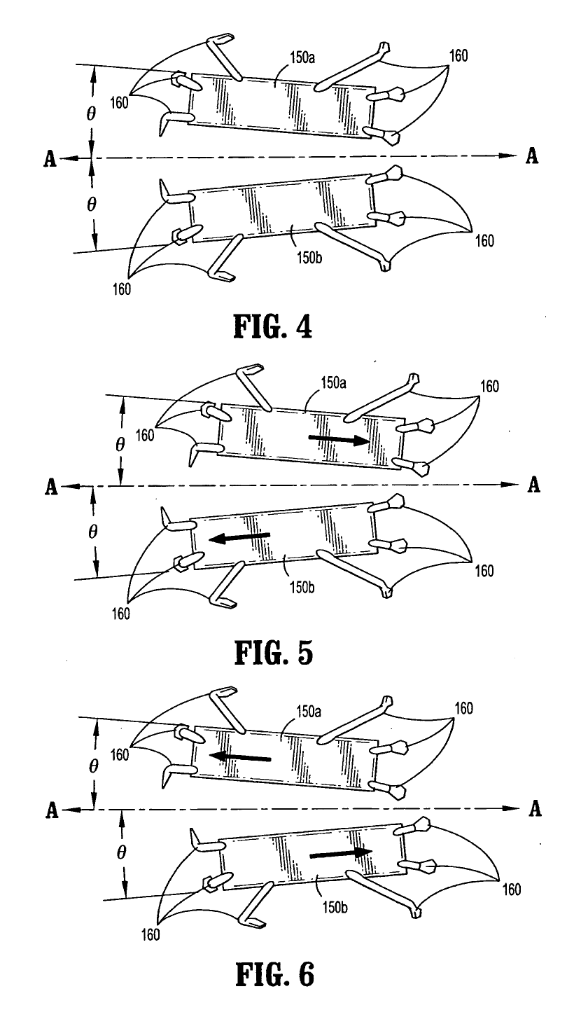

With reference to FIGS. 4-6, arms 140a, 140b and heads 150a, 150b are illustrated disposed at an angle Θ (FIG. 4) from longitudinal axis A-A. Here, arm 140a defines axis B-B and arm 140b defines axis C-C. Disposing arms 140a and 140b at an angle with respect to longitudinal axis A-A may be desirable for various reasons, including increasing the total soil-contacting area. The angle Θ may be any reasonable angle, including all angles between about 5° and about 35° (in addition to being about 0°, substantially parallel). To accommodate proximal and distal movement of arms 140a and 140b at an angle Θ with respect to longitudinal axis A-A, it is envisioned that arms 140a and/or 140b are bent into an corresponding angle, as shown in FIG. 4. It is also envisioned that portions of gear set 130 are angled to facilitate angular reciprocated motion of arms 140a, 140b. Although not explicitly shown, it is envisioned that arms 140a and 140b are adjustable to provide a variety of angles Θ.

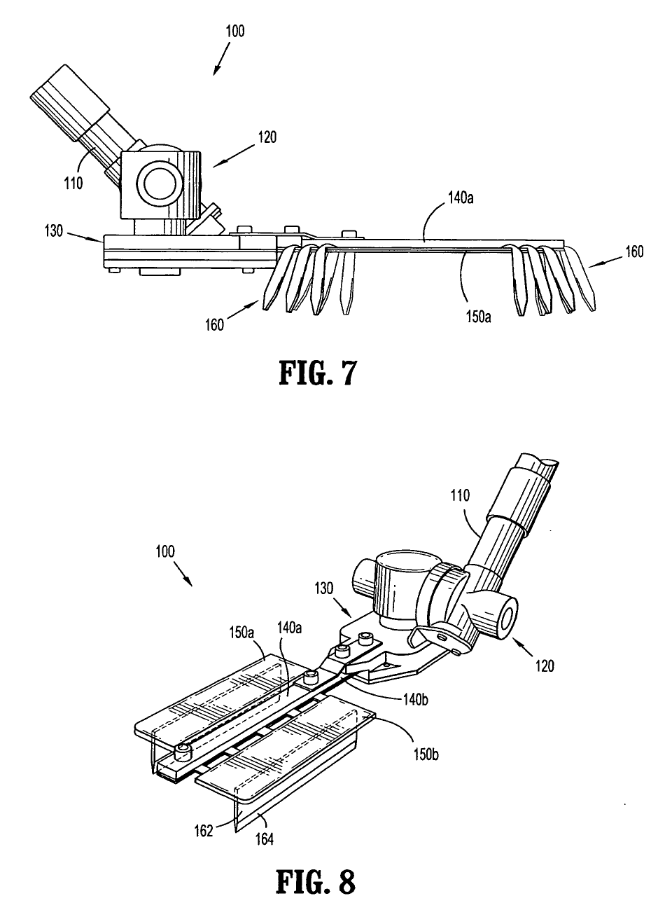

Referring now to FIGS. 1-7 and 9, heads 150a and 150b are each illustrated including a plurality of tines 160. While the same number (i.e., six) of tines 160 is illustrated in each of FIGS. 1-7 and 9, it is envisioned and within the scope of the present disclosure that more or fewer tines 160 are included on each head 150a, 150b. Additionally, each head 150a and 150b may have different number of tines 160 from each other. The arrangement of tines 160 is also similarly illustrated in FIGS. 1-7 and 9 (i.e., each tine 160 is shown in approximately the same location on head 150), however other arrangements are anticipated and within the scope of the present disclosure, including each head 150a and 150b having a different tine 160 arrangement from one another.

With reference to FIG. 8, each head 150a, 150b of ground-working tool 100 includes a blade 162 having an elongated ground-contacting surface 164. Such an embodiment may be desired in certain situations for a particular gardening use. It is also envisioned to include blade 162 in embodiments where arms 140a, 140b are disposed at an angle Θ with respect to longitudinal axis A-A. As can be appreciated, the inclusion of blades 162 (especially blades 162 that are substantially parallel to longitudinal axis A-A) in ground-working tools where the blades rotate 360° would not work very well (if at all). The present disclosure also contemplates heads 150 that are removably securable to arms 140. For instance, grooves (not explicitly shown) or other suitable structure in head 150 may accept arm extensions 141 (shown in FIG. 8) or other suitable structure to enable head 150 to be removably secured to arm 140.

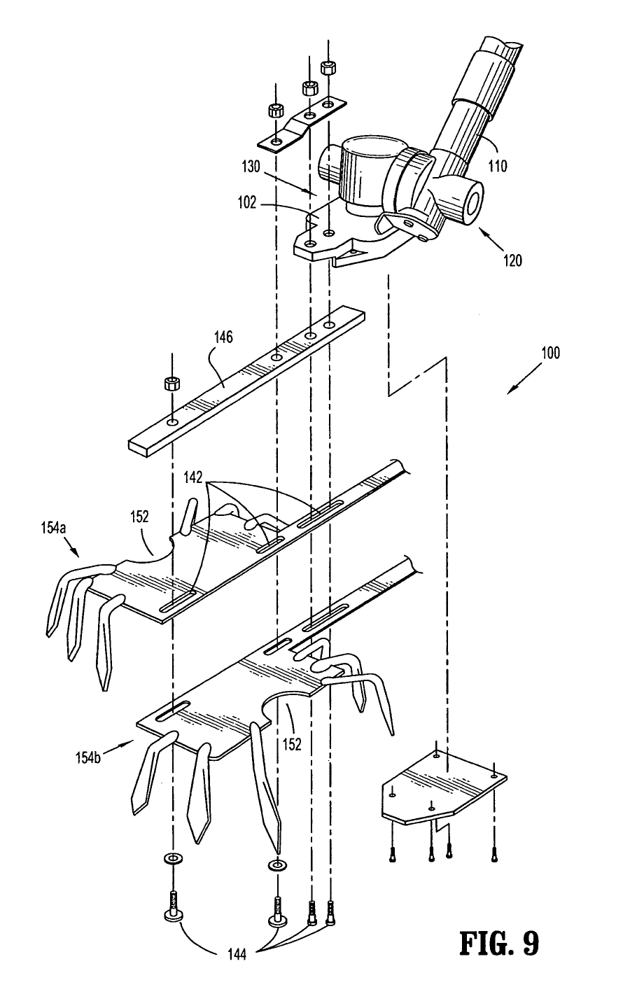

Now referring to FIG. 9, an assembly drawing of portions of ground-working tool 100 is illustrated in accordance with an embodiment of the present disclosure. As is shown, arms 140a and 140b are slidable with respect to each other. This slidable interaction between arms 140a and 140b is facilitated by a series of slots 142a, 142b disposed in each arm 140a, 140b and a plurality of pins 144 (e.g., screws), each of which extend through a slot 142 of each arm 140. A fixed arm 146 is also shown in this embodiment, which is fixedly secured to a housing 102 of ground-working tool 100. Here, arms 140a and 140b are also slidable with respect to fixed arm 146. Additionally, arms 140a and 140b are confined to proximal and distal movement relative to gear set 130 (disposed at least partially within housing 102 and hidden in this figure).

With continued reference to FIG. 9, heads 150a and 150b include a cut-out 152 therein, which reduces the amount of material necessary for manufacturing, and thus reduces the weight of ground-working tool 100. Additionally, a first arm/head set 154a (including arm 140a and head 150a) and a second arm/head set 154b (including arm 140b and head 150b) are each illustrated as being formed by a single piece of material, in accordance with an embodiment of the present disclosure. The material used to construct arms 140a, 140b, heads 150a, 150b or arm/head sets 154a, 154b may include, for example, metal, steel, semi-steel, plastic (e.g., hardened plastic), etc., or any combinations thereof.

FIGS. 10-13 illustrate an example of gear set 130 and how the reciprocated motion is produced. In this embodiment, gear set 130 includes a gear housing 132, a pivot 134, a first gear 136, a first gear box 137, a second gear 138 and a second gear box 139. In this embodiment, pivot 134 is rotated via drive motor 120 (e.g., via bevel gears, not shown). Pivot 134 is in mechanical cooperation with first gear 136 and second gear 138, such that upon rotation of pivot 134, first gear 136 and second gear 138 rotate accordingly. Therefore, as pivot 134 rotates counter-clockwise in the direction of arrows CC in FIGS. 10-13, for example, first gear 136 and second gear 138 also rotate counter-clockwise. Further, first gear box 137 and second gear box 139 are slidably mounted within gear housing 132.

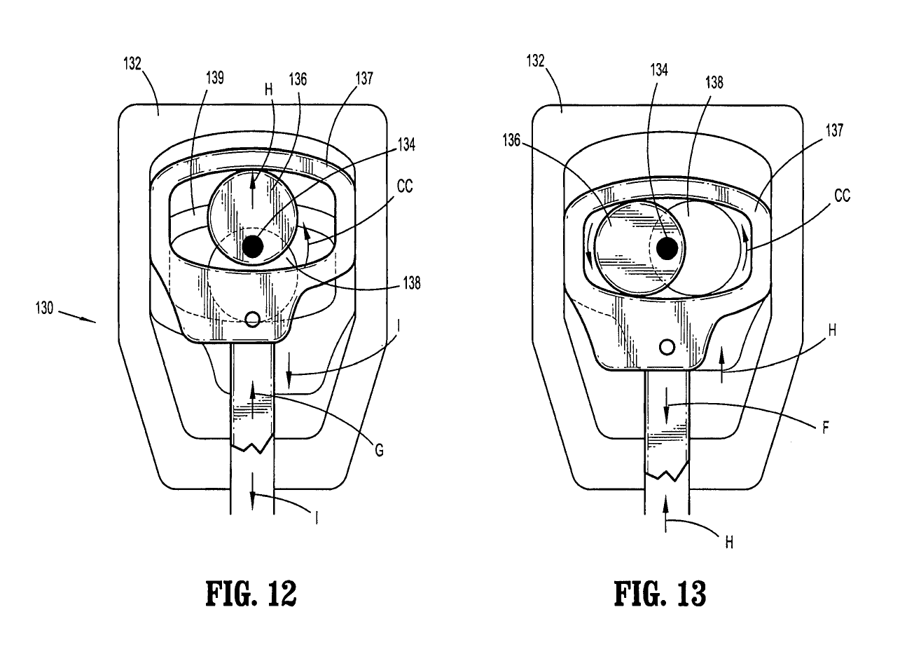

As can be seen with reference to FIGS. 10-13, rotation of first gear 136 and second gear 138 causes first gear box 137 and second gear box 139, respectively, to travel distally and proximally within gear housing 132. More specifically, FIGS. 10-13 illustrate a complete rotation of first gear 136 and second gear 138 and the corresponding motion of arms 140a and 140b, mechanically secured to first gear box 137 and second gear box 139, respectively. When first gear 136 is rotated distally relative to pivot 134, first gear box 137 and first arm 140a are translated distally in the direction of arrow F in FIG. 10. Upon continued rotation of pivot 134, the corresponding rotation of first gear 136 causes first gear box 137 and first arm 140a to move proximally in the direction of arrow G (FIG. 11). The continued rotation of pivot 134 and first gear 136 are illustrated in FIGS. 12 and 13. Second gear 138 is shown disposed about 180° opposite of first gear 136. Thus, as pivot 134 rotates, second gear 138, second gear box 139 and second arm 140b move in opposite directions as first arm 140a (i.e., second arm 140b moves proximally in the direction of arrow H in FIG. 10 and distally in the direction of arrow I in FIG. 11). It is also envisioned and within the scope of the present disclosure that other types of gears and combination of gears may be used to produce reciprocated motion.

The present disclosure also relates to a ground-working attachment 200 (see FIG. 1, for example) that is removably securable to shaft 110. Attachment 200 includes a housing 210, gear set 130, at least one arm 140 and at least one head 150. Gear set 130 is disposed at least partially within housing 210. Arm 140 is disposed in mechanical cooperation with gear set 130 and arm 140 is movable proximally and distally in a reciprocating motion, as described above with reference to ground-working tool 100. Head 150 is disposed in mechanical cooperation with arm 140.

The present disclosure also relates to a method of cultivating soil. The method includes the steps of providing a tool, such as ground-working tool 100 described above, activating drive motor 120 and placing at least a portion of the tool adjacent soil.

While the above description contains many specifics, these specifics should not be construed as limitations on the scope of the present disclosure, but merely as illustrations of various embodiments thereof. Therefore, the above description should not be construed as limiting, but merely as exemplifications of various embodiments. Those skilled in the art will envision other modifications within the scope and spirit of the claims appended hereto.

What is claimed:

1. A ground-working tool, comprising:
a shaft;
a drive motor disposed in mechanical cooperation with the shaft;
a gear set configured to be driven by the drive motor;
at least one arm disposed in mechanical cooperation with the gear set and defining a longitudinal axis, wherein the at least one arm is movable proximally and distally in a reciprocating motion; and
at least one head disposed in mechanical cooperation with the at least one arm.

2. The tool according to claim 1, wherein the at least one arm includes a first arm defining a first longitudinal axis and a second arm defining a second longitudinal axis, wherein activation of the drive motor causes the first arm and the second arm to reciprocatingly move in opposite directions from each other.

3. The tool according to claim 2, wherein the first longitudinal axis and the second longitudinal axis are substantially parallel to one another.

4. The tool according to claim 2, wherein the first longitudinal axis and the second longitudinal axis are disposed at an angle Θ to one another, the angle Θ being between about 5° and about 35°.

5. The tool according to claim 1, wherein the head includes a plurality of tines.

6. The tool according to claim 1, wherein the head includes a blade having an elongated ground-contacting surface, the elongated ground-contacting surface disposed substantially parallel to the longitudinal axis.

7. The tool according to claim 1, wherein the arm is confined to proximal and distal movement relative to the gear set.

8. The tool according to claim 1, wherein the head is removably secured to the arm.

9. The tool according to claim 1, wherein at least a portion of the tool is configured to be hand-held.

10. A ground-working attachment being removably securable to a hand held motorized shaft, the attachment comprising:
a housing;
a gear set disposed at least partially within the housing;
at least one arm disposed in mechanical cooperation with the gear set and defining a longitudinal axis, wherein the at least one arm is movable proximally and distally in a reciprocating motion; and
at least one head disposed in mechanical cooperation with the at least one arm.

11. The attachment according to claim 10, wherein the at least one arm includes a first arm defining a first longitudinal axis and a second arm defining a second longitudinal axis, wherein activation of the drive motor causes the first arm and the second arm to reciprocatingly move in opposite directions from each other.

12. The attachment according to claim 10, wherein the head includes a plurality of tines.

13. The attachment according to claim 10, wherein the head includes a blade having an elongated ground-contacting surface, the elongated ground-contacting surface disposed substantially parallel to the longitudinal axis.

14. The attachment according to claim 10, wherein the arm is confined to proximal and distal movement relative to the gear set.

15. The attachment according to claim 10, wherein the head is removably secured to the arm.

16. A method of cultivating soil, including the steps of:
providing a tool, including:
shaft having a drive motor; and
at least one arm disposed in mechanical cooperation with the shaft and defining a longitudinal axis, wherein the at least one arm is movable proximally and distally in a reciprocating motion;
activating the drive motor to cause the arm to reciprocate; and
placing at least a portion of the tool adjacent soil.

17. The method according to claim 16, further including a first arm defining a first longitudinal axis and a second arm defining a second longitudinal axis, wherein activation of the drive motor causes the first arm and the second arm to reciprocatingly move in opposite directions from each other.

18. The method according to claim 16, further including a plurality of tines disposed in mechanical cooperation with the arm.

19. The method according to claim 16, further including a blade disposed in mechanical cooperation with the arm and having an elongated ground-contacting surface.
